(19) United States
(12) Patent Application Publication
(10) Pub. No.: US 2015/0108941 A1
(43) Pub. Date: Apr. 23, 2015

(54) Self contained battery charger

(71) Applicant: Tony Czajkowski, Karnack, TX (US)

(72) Inventor: Tony Czajkowski, Karnack, TX (US)

(21) Appl. No.: 14/059,439

(22) Filed: Oct. 21, 2013

(51) Int. Cl. H02J 7/00

(52) U.S. Cl. CPC H02J 7/0042
USPC 320/107

(57) ABSTRACT

Electrical current passed along a metallic non-generating coil oscillates towards the energy producing coil. The metallic coils are tightly woven around a nonconductive inner cylinder which serves the function of maintaining the integrity of the metallic energy generating and non-generating outer coils. This cylinder also provides housing for the internal energy generating coils. The generating and non-generating coils are wrapped opposite to each other which force the movement and acceleration of electrons against each other and the production of excess energy occurs. The electric energy output exceeds energy input of the device. The output from this device makes it a self-sustaining energy generator of electric power for useful purposes.

### CROSS-REFERENCE TO RELATED APPLICATIONS

None

### STATEMENT REGARDING FEDERALLY SPONSORED RESEARCH OR DEVELOPMENT

None

### BACKGROUND OF THE INVENTION

This self-contained battery charger was invented with the intent for use in small hand-held devices with batteries requiring frequent electrical charging. It has been used continuously for over one year and has provided a dependable source of constant electricity sufficient to charge both NiCad and Lithium batteries such as those found in cell phones.

### DESCRIPTION OF THE DRAWINGS

FIG. 1 1) Non-conductive cylinder.

FIG. 2 2) Using one continuous piece of insulated copper wire leave a tail protruding from the end of the non-conductive cylinder then wind the wire into 84 clockwise coils around the non-conductive cylinder. 3) On the 85^{th} coil make a ½ loop, reversing the direction of the outer coil layer.

FIG. 3 4) Continue wrapping the wire in a counter-clockwise direction for an additional 27 wraps to make an induction coil. 5) The trailing wire end is the positive tail of the induction coil. A battery terminal is attached to this end. This is the positive charge for the power battery. 6) Wrap a second generating coil, consisting of insulated copper wire 1½ times larger in diameter than the first wire, is wound in a double spaced counterclockwise direction for 10 turns. This generating coil is the positive output which requires the attachment of a terminal which will then be connected to the positive post of the battery to be charged. 7) Leave a trailing wire end on the larger outer generating coil. As indicated, solder trailing end number 7) to trailing end number 2). Use a heat shrink and encase this soldered area.

FIG. 4 8) This device is the ground core. Using one continuous piece of insulated copper wire leave a working tail of several inches. Strip the insulation. Take the remaining wire and make five equal lengths of folded wire. The length of the fold is determined by the length of the non-conductive cylinder. 9) Leave a working tail at the end of the final wire fold. Snip the folds at both ends of the wire and strip the insulation. Twist the bare ends to the stripped working tail, solder, shrink wrap and bond ensuring that the working tail retains one inch of bare wire for attachment to connectors.

FIG. 5 10) Twist the strands completing the inner ground core.

FIG. 6 11) Take the trailing end of the ground core and wrap it around the twisted strand ensuring the tail extends past the end of the non-conductive cylinder. Twist the bare ends to the stripped working tail and bond ensuring that the working tail retains one inch of bare wire for attachment to connectors. This wrap is used solely to hold the five inner wires twist in place.

FIG. 7 Insert the ground core inside the non-conductive cylinder.

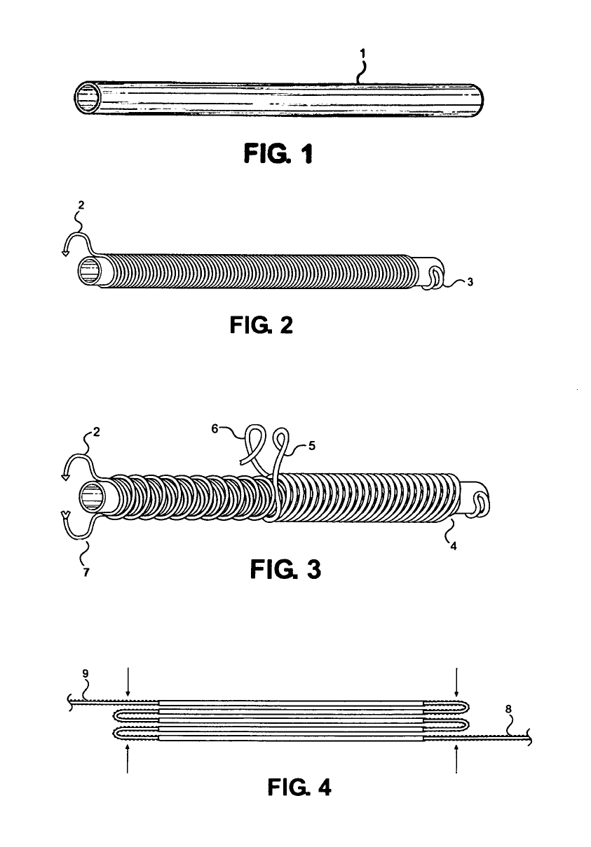

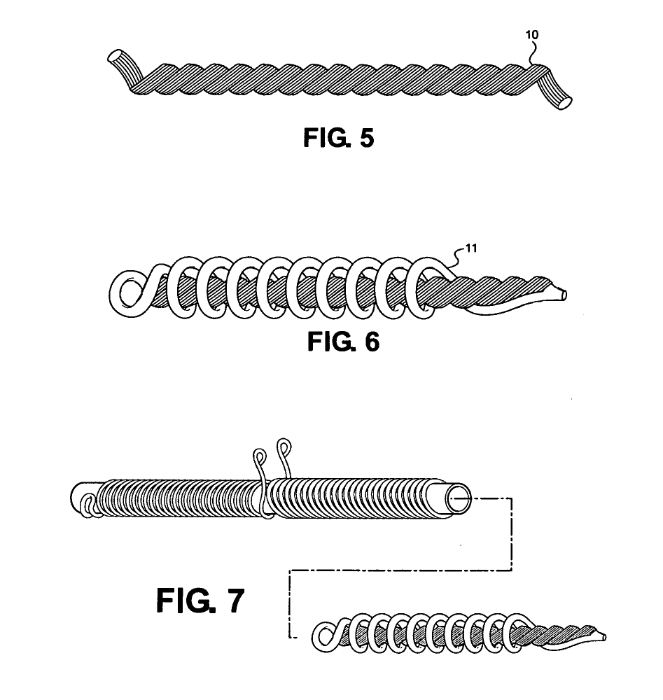

### DESCRIPTION OF THE INVENTION

The inner core serves as a ground. It generates both positive and negative output. The ground core positive terminal attaches to the hot battery and the negative terminal of the hot battery attaches to the induction coil. The battery receiving the charge is attached to the positive terminal of the generating coil and the negative terminal of the ground coil. No regulators are needed as the voltage will only go as high as the rating of the attached battery.

### SUMMARY

This self-contained battery charger is made from a non-conductive inner core which is used specifically to hold the inner and outer cores. These two cores are made of various sizes of insulated copper wires wrapped in both clockwise and counter-clockwise manners which force the movement of electrons in opposite directions thereby creating a constant source of electrical output. This output is captured when battery terminal ends are applied to the trailing wires of the self-contained battery charger and it is attached to the appropriate sized battery. The device produces sufficient constant energy to ensure the battery retains a charge even when a load is placed on it, i.e. the battery is placed in a cell phone it will work without additional sources of energy to charge the battery. This self-contained battery charger must be attached to an electrical storage device such as a battery for it to work.

1. This is a self-generating electrical device. The electric energy output exceeds energy input of the device. The output from this device makes it a self-sustaining energy generator of electric power for useful purposes such as keeping a battery charged for external consumption.
